(19) United States
(12) Patent Application Publication
(10) Pub. No.: US 2023/0214795 A1
(43) Pub. Date: Jul. 6, 2023

(54) Virtual currency automatic exchange method of virtual currency teller machine

(71) Applicant: NuMiner Technologies Ltd., Taipei City (TW)

(72) Inventor: YUAN-CHENG HSU, Taipei City (TW)

(73) Assignee: NuMiner Technologies Ltd., Taipei City (TW)

(21) Appl. No.: 17/572,693

(22) Filed: Jan. 11, 2022

(30) Foreign Application Priority Data
Dec. 30, 2021 (TW) 110149664

(51) Int. Cl. G06Q 20/06

(52) U.S. Cl. CPC G06Q 20/065

(57) ABSTRACT

a virtual currency automatic exchange method of virtual currency teller machine, adopted to an operator to buy/sell at least one kind of virtual currency through a mobile processing device and import/export a cash corresponding to the virtual currency to the operator, wherein the virtual currency teller machine has a mining machine for hash operations or other accounting and operations to obtain and store the virtual currency, a connection interface unit and a processing unit, wherein the processing unit is signally connected to the mining machine and the connection interface unit, comprising the steps of: (a) connecting the connection interface unit with the mobile processing device; (b) the processing unit determining whether the virtual currency can be bought/sold; and (c) the processing unit controlling the mining machine to transfer out/in the virtual currency and receive/pay to the cash if yes.

### BACKGROUND OF THE INVENTION

### 1. Field of the Invention

The present invention is in related to a virtual currency automatic exchange method of virtual currency teller machine, more particularly to related fields of virtual currency transactions.

### 2. Description of the Prior Art

Bitcoin ATM is an automatic machine for exchanging Bitcoin, other kinds of virtual currencies and cash. Some kinds of Bitcoin ATM have a 2-way function. That is, operators are able to purchase Bitcoin and sell bitcoin for cash. Under some circumstances, providers for the Bitcoin ATM ask operators who hold accounts are able to conduct transactions by means of the Bitcoin ATM.

In prior arts, when a Bitcoin ATM performs a transaction, the virtual currencies are not immediately displayed in an operator mobile wallet, and a plurality of authentications are required before the transaction is finally confirmed, and the time of each authentication will be determined according to the link amount of information. The larger amount of linking information, the longer waiting time. Generally speaking, it takes at least ten minutes or even dozens of minutes for each authentication, which is too time-consuming for operators. Therefore, the prior arts are still space for large improvements.

Consequently, how to improve the shortcomings as aforesaid becomes an important issue to the people skilled in the art.

### SUMMARY OF THE INVENTION

The main object of the present invention is to provide virtual currency teller machine with a mining machine.

The secondary object of the present invention is to provide a method for determining whether an operator is able to buy/sell virtual currencies.

The third object of the present invention is to provide a method for rapidly obtaining virtual currencies or cash corresponding the amount of the virtual currencies.

Preferably, a virtual currency automatic exchange method of virtual currency teller machine, adopted to an operator to buy/sell at least one kind of virtual currency through a mobile processing device and import/export a cash corresponding to the virtual currency to the operator, wherein the virtual currency teller machine has a mining machine for hash operations or other accounting and operations to obtain and store the virtual currency, a connection interface unit and a processing unit, wherein the processing unit is signally connected to the mining machine and the connection interface unit, comprising the steps of: (a) connecting the connection interface unit with the mobile processing device; (b) the processing unit determining whether the virtual currency can be bought/sold; and (c) the processing unit controlling the mining machine to transfer out/in the virtual currency and receive/pay to the cash if yes.

Preferably, the step (a) further comprises the steps of: (a1) determining whether the operator has an exclusive electronic wallet, if no, applying the electronic wallet; and (a2) signing in to the exclusive electronic wallet if the operator does have the exclusive electronic wallet.

Preferably, the virtual currency teller machine further comprises a video shooting unit that is signally connected with the processing unit, and the mobile processing device is a smartphone, wherein the steps, after the step (a2), further are of: (a3) the video shooting unit capturing an identity certificate of the operator; (a4) guiding the operator to input a smartphone number; (a5) sending a one-time SMS password to the smartphone according to the smartphone number; and (a6) guiding the operator to input the one-time SMS password in order to determine whether the one-time SMS password is true, otherwise re-inputting or re-sending the other one-time SMS password.

Preferably, the step (a1) further comprises the steps of: (a11) guiding the operator to input an e-mail address; (a12) sending a one-time e-mail password to the e-mail address according to the e-mail address; (a13) guiding the operator to input the one-time e-mail password in order to determine the one-time e-mail password is true, otherwise re-inputting or re-sending the other one-time e-mail password; and (a14) if yes, the electronic wallet being established.

Preferably, the virtual currency teller machine further comprises a display unit that is signally connected with the processing unit, the connection interface unit being a QR code on the display unit, the mobile processing device further comprising an image capturing unit, the step (b) comprising the steps of: (b1) the display unit displaying the QR code in order to let the image capturing unit read and confirm an address of the virtual currency if the operator buys the virtual currency; and (b2) guiding the operator to input a cash amount of buying the virtual currency.

Preferably, the virtual currency teller machine further comprises a printing unit that is signally connected with the processing unit, the step (c) comprising the steps of: (c1) the processing unit confirming to receive the cash; (c2) the display unit displaying billing information; and (c3) the printing unit printing a receipt corresponding to the billing information.

Preferably, the virtual currency teller machine further comprises a display unit that is signally connected with the processing unit, the connection interface unit being a QR code on the display unit, the mobile processing device further comprising an image capturing unit, the step (b) comprising the steps of: (b1′) guiding the operator to input a cash amount of selling the virtual currency if the operator sells the virtual currency; (b2′) the processing unit confirming that the operator has enough virtual currency; and (b3′) if yes, the display unit displays the QR code in order to let the image capturing unit read and confirm an address of the virtual currency.

Preferably, the virtual currency teller machine (1) further comprises a printing unit that is signally connected with the processing unit, the step (c) comprising the steps of: (c1′) the operator transferring the virtual currency; (c2′) the printing unit printing a voucher of the cash amount of the virtual currency; (c3′) the image capturing unit reading the voucher and allocating the corresponding cash to the operator; (c4′) the display unit displaying billing information; and (c5′) the printing unit printing a receipt corresponding to the billing information.

Preferably, the step (c3′) comprises the steps of: (c31′) the processing unit determining whether the transferred virtual currency is received, if no, the display unit displaying that the transferred virtual currency is not received; and (c32′) if yes, the display unit displaying that the transferred virtual currency is received, and allocating the corresponding cash to the operator.

Preferably, the virtual currency teller machine further comprises a cash box that is signally connected with the processing unit, wherein the cash box is to store cash, so that the cash is collected/paid by the cash box.

The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits, and advantages of the preferred embodiments of the present invention will be readily understood by the accompanying drawings and detailed descriptions, wherein:

FIG. 1 illustrates a schematic block diagram of a virtual currency teller machine of the present invention;

FIG. 2 illustrates a preferred embodiment of the present invention; and

FIG. 3 to FIG. 7 illustrate schematic flow charts of the present invention.

### DETAILED DESCRIPTION OF THE INVENTION

In order to describe in detail the technical content, structural features, achieved objectives and effects of the instant application, the following detailed descriptions are given in conjunction with the drawings and specific embodiments. It should be understood that these embodiments are only used to illustrate the application and not to limit the scope of the instant application.

All of the figures of the present invention are schematic views, and shown the relationships among the modules and signals, but the ratios of the circuits' dimensions, the signals' waveforms and the frequencies are not included.

The present invention is a virtual currency automatic exchange method of virtual currency teller machine 1, which is adopted to an operator to buy/sell at least one kind of virtual currency through a mobile processing device 2 and import/export a cash corresponding to the virtual currency to the operator. The virtual currency teller machine 1 has a mining machine 11 for hash operations or other accounting and operations to obtain and store the virtual currency, a connection interface unit 13 and a processing unit 14, wherein the processing unit 14 is signally connected to the mining machine 11 and the connection interface unit 13. Through the connection of the connection interface unit 13 and the mobile processing unit 14, the processing unit 14 determines whether the virtual currency can be bought/sold. If yes, the processing unit 14 controls the mining machine 11 to transfer out/in the virtual currency and receive/pay to the cash. The present invention is able to directly buy/sell virtual currency via the processing unit 14 controlling the mining machine 11, so as to significantly reduces authentication time and improves transaction efficiency.

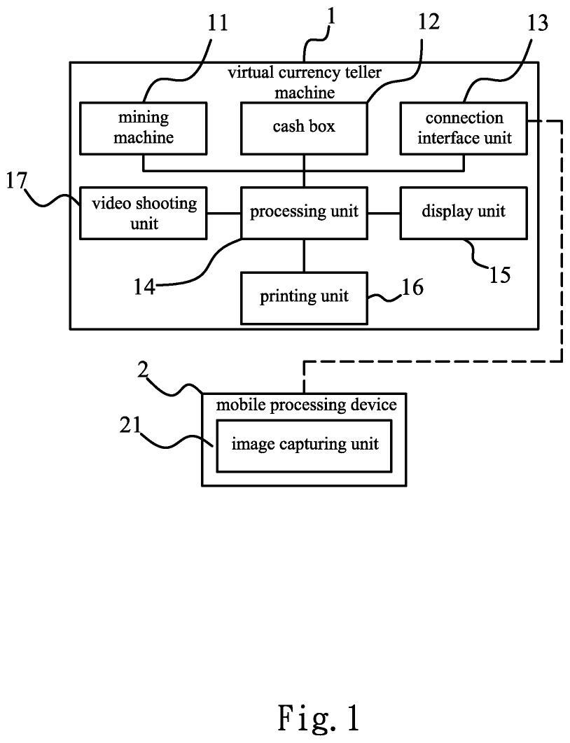

Please refer to FIG. 1, which illustrates a schematic block diagram of the virtual currency teller machine of the present invention. The virtual currency teller machine 1 includes the mining machine 11, the connection interface unit 13, the processing unit 14, a video shooting unit 17, a display unit 15, a printing unit 16, and a cash box 12. Following will describe the connections among aforesaid units.

The mining machine 11 is for hash operations or other accounting and operations to obtain and store the virtual currency. Simply speaking, the mining machine 11 obtains the virtual currency by means of mining. For the embodiment, the mining machine 1 grabs the virtual currency by way of consuming electricity and time and fully loading a graphics card (GPU), so as to obtain and store the virtual currency. It decreases the time of multiple identifications to a virtual currency teller machine in prior arts. The virtual currency teller machine 1 further comprises the cash box 12 that is signally connected with the processing unit 14, wherein the cash box 12 is to store cash, so that the cash is collected/paid by the cash box 12.

The processing unit 14 is signally connected with the mining machine 11 and the connection interface unit 13, and able to determine whether the virtual currency can be bought/sold. In addition, the connection interface unit 13 is connected with the mobile processing device 2. As the embodiment, the mobile processing device 2 is a smartphone, a tablet PC or a laptop, in order to let the operator do some virtual currency exchanging business and transfer out/in the virtual currency to the cash of the operator while the mobile processing device 2 is connected with the connection interface unit 13.

The virtual currency teller machine 1 further comprises a video shooting unit 17 that is signally connected with the processing unit 14. The video shooting unit 17 captures an identity certificate of the operator. If the processing unit 14 determines that the operator has an exclusive electronic wallet, the operator signs in to the exclusive electronic wallet. The shooting unit 17 captures an identity certificate of the operator, so as to guide the operator providing a smartphone number. According to the smartphone number, a one-time SMS password is sent to the smart phone for inputting and identifying.

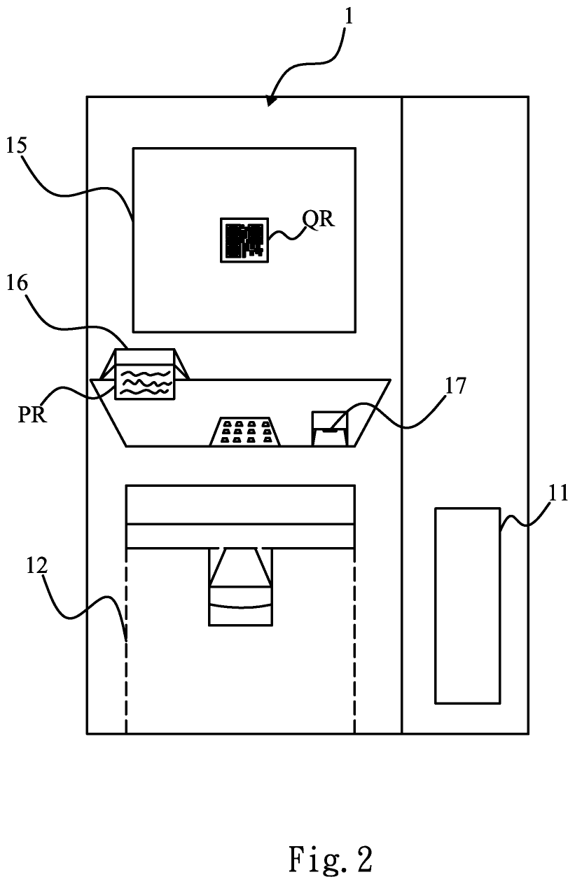

Please refer to FIG. 2, which illustrates a preferred embodiment of the present invention. The virtual currency teller machine 1 further comprises the display unit 15 that is signally connected with the processing unit 14. The connection interface unit 13 is a QR code on the display unit 15. Based on the preferred embodiment, the display unit 15 displays the QR code in order to let the image capturing unit 21 of the mobile processing device 2 read and confirm an address of the virtual currency if the operator buys the virtual currency. Consequently, a cash amount of buying the virtual currency is input. Additionally, if the operator sells the virtual currency, the processing unit 14 confirms that the operator has enough virtual currency. If yes, the display unit 15 displays the QR code in order to let the image capturing unit 21 read and confirm an address of the virtual currency.

The virtual currency teller machine 1 further comprises the printing unit 16 that is signally connected with the processing unit 14. Especially, the printing unit 16 prints a receipt corresponding to the billing information of the virtual currency and a voucher of the cash amount of the virtual currency. When the processing unit 14 determines that the operator buys some virtual currencies, the processing unit 14 controls the mining machine 11 to transfer out the virtual currencies correspondingly and charge the user in cash corresponding to the denomination of the virtual currencies. The operator may put the cash into the virtual currency teller machine 1, then to the cash box 2. Continuously, the display unit 15 displays a billing information corresponding to above virtual currency transaction for the operator confirmation. After that, the printing unit 16 prints a receipt corresponding to the billing information of the virtual currency transaction, so as to provide the operator to store. On the other hand, as soon as the processing unit 14 determines that the operator buys some virtual currencies, the operator may transfer out the virtual currencies correspondingly and print out a voucher of the cash amount of the virtual currencies via the printing unit 16. The image capturing unit 21 of the mobile processing device 2 reads the voucher and allocates the corresponding cash to the operator from the cash box 12. The display unit 15 thus displays the billing information related to the transaction, and the printing unit 16 prints a receipt corresponding to the billing information.

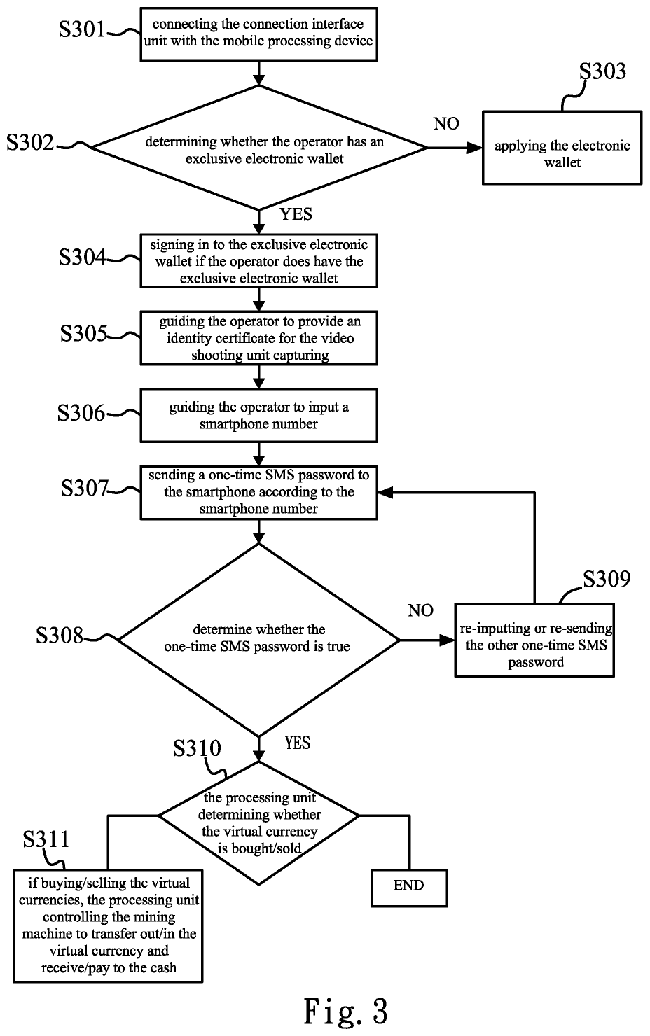

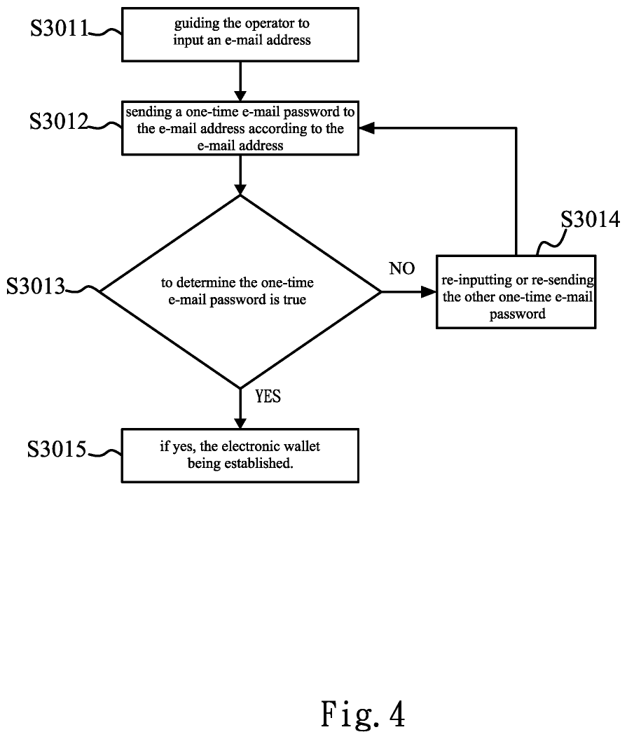

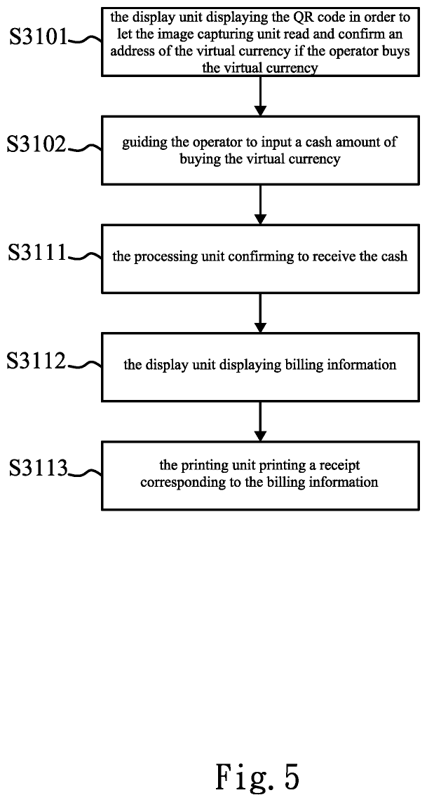

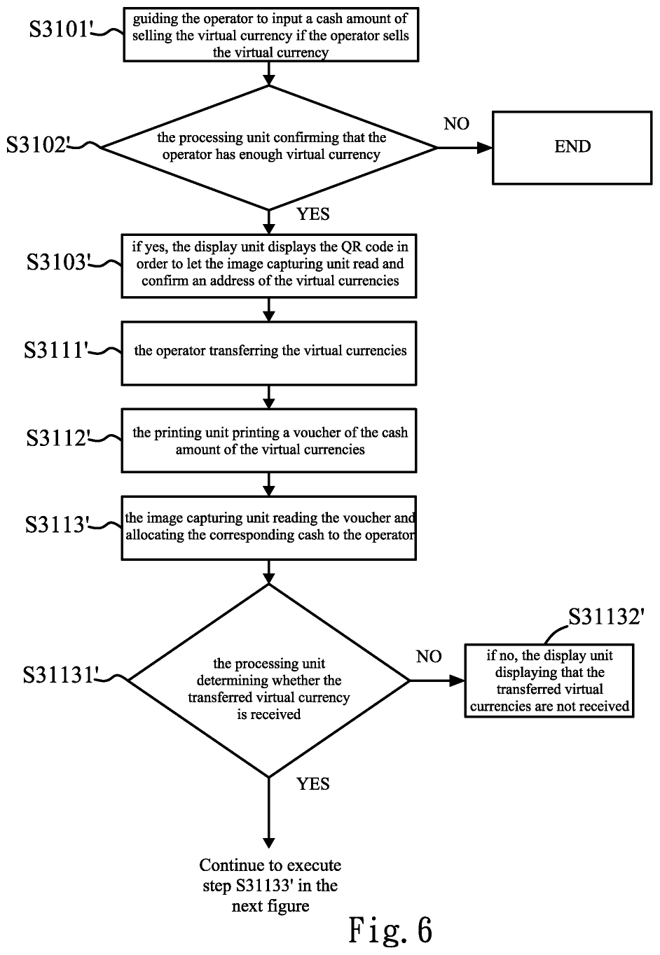

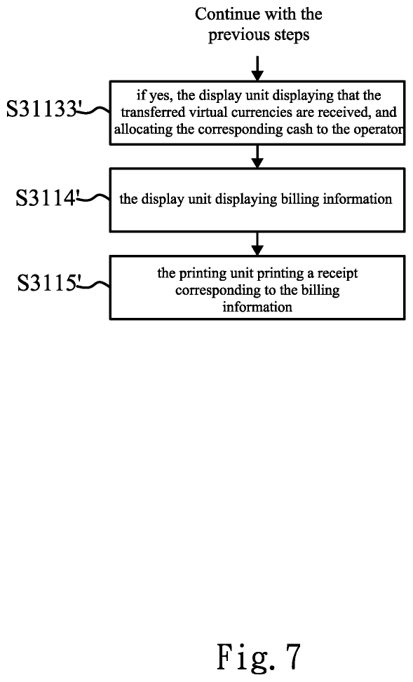

With reference to FIG. 3 to FIG. 7, which illustrate schematic flow charts of the present invention. The present invention is as aforesaid method for automatically exchanging the virtual currency of the virtual currency teller machine. That is, an operator buys/sells at least one kind of virtual currency through a mobile processing device 2 and imports/exports a cash corresponding to the virtual currency to the operator. For the embodiment, the mobile processing device 2 is a smart phone. The step (S301) is of connecting the connection interface unit 13 with the mobile processing device 2. The connection interface unit 13 is a role for connecting the mobile processing device 2 with the virtual currency teller machine 1 for the operator. The step (S302) is of determining whether the operator has an exclusive electronic wallet. When the operator is connected with the connection interface unit 13 of the virtual currency teller machine 1 through the mobile processing device 2, the processing unit 14 may evaluate whether the operator has an exclusive electronic wallet. The step (S303) is of applying the electronic wallet if no. That is, if the operator does not have the electronic wallet, the processing unit 14 is able to guide the operator to go some application procedures for the electronic wallet.

If yes, then the step (S304) is executed. The step (S304) is of signing in to the exclusive electronic wallet if the operator does have the exclusive electronic wallet. In other words, as soon as the operator has the exclusive electronic wallet, the processing unit 14 may guide the operator to sign in to the exclusive electronic wallet. After that, the virtual currency teller machine 1 guides the operator to provide an identity certificate for the video shooting unit 17 capturing, as in the step (S305), so as to confirm the operator.

After capturing, the step (S306) is in execution. The step (S306) is of guiding the operator to input a smartphone number. That is, after the identity certificate is shoot, the operator may be guide to input a smartphone number. The step (S307) is of sending a one-time SMS password to the smartphone according to the smartphone number. That is to say, the one-time SMS password is delivered to the smartphone based on the smartphone number input by the operator. Further, there is a time frame for inputting the one-time SMS password after the smartphone receives the one-time SMS password, in order to pass relevant identity verification and communication verification.

The step (S308) is of guiding the operator to input the one-time SMS password in order to determine whether the one-time SMS password is true. More descriptions, as soon as the smartphone receives the one-time SMS password, a number from the one-time SMS password will be input to the virtual currency teller machine 1 for verification, and then moving to the step (S310). Once an incorrect happens, the step (S309) is of re-inputting or re-sending the other one-time SMS password.

If the operator does not have the exclusive electronic wallet, the operator will be guided to apply for the exclusive electronic wallet. That is to execute the step (S3011), which is of guiding the operator to input an e-mail address. As aforesaid, the operator with no the exclusive electronic wallet may be guided to apply, and first the operator must input an e-mail address himself, then the step (S3012) can be executed. The step (S3012) is of sending a one-time e-mail password to the e-mail address according to the e-mail address. After the e-mail is input and sent, the virtual currency teller machine 1 sends a one-time e-mail password to the operator, then the step (S3013) is in execution and of guiding the operator to input the one-time e-mail password in order to determine the one-time e-mail password is true. In another word, the operator receives the one-time e-mail password first, then the operator inputs contents of the one-time e-mail password to the virtual currency teller machine 1, so as to check whether the one-time e-mail password is true or false via the processing unit 14. If no, then the step (S3014), which is of re-inputting or re-sending the other one-time e-mail password. Consequently, the step (S3015) is of if yes, the electronic wallet being established. Simply speaking, when the one-time e-mail password is approved by the processing unit 14, the exclusive electronic wallet is ready, in order to let the operator do some virtual currency exchanging procedures.

The step (S310) is of the processing unit 14 determining whether the virtual currency is bought/sold. In other words, after going through aforementioned identity verification and electronic wallet confirmation, the virtual currency teller machine 1 is capable of determining whether the operator can do some virtual currency exchanging procedures by means of the processing unit 14. If the operator buying virtual currencies is a need, the step (S3101) is in processed. The step (S3101) is of the display unit 15 displaying the QR code in order to let the image capturing unit 21 read and confirm an address of the virtual currency if the operator buys the virtual currency. Therefore, further descriptions, when the operator wants to buy virtual currencies, the display unit 15 of the virtual currency teller machine 1 will display the QR code. Continuously, the operator reads the QR code through the image capturing unit 21 of the mobile processing device 2, and confirms the e-mail address of the virtual currencies.

The step (S3102) is of guiding the operator to input a cash amount of buying the virtual currency. Frankly speaking, after the operator scans the QR code and confirms the e-mail address of the virtual currency, the operator is guided to input a corresponding cash amount for purchasing the required amount of virtual currency. For example, the exchange rate on the day is one virtual currency versus NT$50,000. If you buy two virtual currencies, you need NT$100,000, and the input cash amount is 100,000. The step (S3111) is of the processing unit 14 confirming to receive the cash. When the operator confirms the exchange rate and inputs the corresponding cash amount, these incoming cash are counted by the processing unit 14 for confirmation, then stored in the cash box 12.

The step (S3112) is of the display unit 15 displaying billing information. Further in detail, when the processing unit 14 of the virtual currency teller machine 1 confirms the input cash amount of the operator is true, and the incoming cash is stored in the cash box 12, the display unit 15 of the virtual currency teller machine 1 may display relevant billing information about the virtual currency transaction, that is defined as billing information.

The step (S3113) is of the printing unit 16 printing a receipt corresponding to the billing information. That is to say, when the display unit 15 of the virtual currency teller machine 1 presents the relevant billing information about the virtual currency transaction, the printing unit 16 of the virtual currency teller machine 1 prints out a receipt corresponding to the billing information for re-confirmation and storage.

If the operator needs to sell virtual currencies, the step (S3101′) is in execution. The step (S3101′) is of guiding the operator to input a cash amount of selling the virtual currency if the operator sells the virtual currency. In other words, when the operator wants to sell the virtual currency, the operator may be guided by the virtual currency teller machine 1 first, and then input an amount of selling virtual currencies and a corresponding cash amount. The step (S3102′) is continuously executed and of the processing unit 14 confirming that the operator has enough virtual currency. For more descriptions, when the operator confirms the amount of selling virtual currencies and the corresponding cash amount, the processing unit 14 of the virtual currency teller machine 1 may confirm that the amount of the virtual currencies hold by the operator is greater than the amount of the virtual currencies input by the operator. Consecutively, the step (S3103′) is of if yes, the display unit 15 displays the QR code in order to let the image capturing unit 21 read and confirm an address of the virtual currencies. In detail, when the processing unit 14 makes sure that the amount of the virtual currencies hold by the operator is enough to be sold for cash, the display unit 15 will show a QR code related the sold virtual currencies for the image capturing unit 21 of the mobile processing device 2 reading, so as to confirm an e-mail address of the sold virtual currencies. Therefore, a virtual currency transaction is ready to start.

Following will discuss the step (S3111′), which is of the operator transferring the virtual currencies. Simply speaking, the operator scans the QR code by way of the image capturing unit 21 of the mobile processing device 2 in order to start the transferring procedures of the virtual currency transaction. The step (S3112′) is of the printing unit 16 printing a voucher of the cash amount of the virtual currencies. In details, after the transferring procedures of the virtual currency transaction are finished by the virtual currency teller machine 1, the printing unit 16 of the virtual currency teller machine 1 will print out the voucher of the cash amount of the virtual currencies to the operator, thus the following steps are still going. The step (S3113′) is of the image capturing unit 21 reading the voucher and allocating the corresponding cash to the operator. In another word, the virtual currency teller machine 1 prints out the voucher of the cash amount of the virtual currencies to the operator, and the image capturing unit 21 of the mobile processing device 2 scans and reads the voucher, the cash corresponding to the amount of the virtual currencies may then be taken out from the cash box 12 to the operator.

The step (S3113′) further comprises the step (S31131′) and the step (S31133′). The step (S31131′) is of the processing unit 14 determining whether the transferred virtual currency is received. In fact, the processing unit 14 of the virtual currency teller machine 1 determines that the transferred virtual currencies by the operator are not received while the operator is scanning the voucher, the step (S31132′) is thus executed, wherein the step (S31132′) is of if no, the display unit 15 displaying that the transferred virtual currencies are not received. Since the display unit 15 displays the information of not receiving the transferred virtual currencies, the virtual currency transaction is finished. Otherwise, the step (S31133′) is in execution, and the step (S31133′) is of if yes, the display unit (15) displaying that the transferred virtual currencies are received, and allocating the corresponding cash to the operator. Simply speaking, if the processing unit 14 determines that the transferred virtual currencies from the operator are received, therefore the cash corresponding to the value of the virtual currencies are allocated to the operator.

After the operator has the cash, the step (S3114′) is processed. The step (S3114′) is of the display unit 15 displaying billing information. In detail, after the operator obtains the cash from the virtual currency teller machine 1, the display unit 15 of the virtual currency teller machine 1 shows the billing information regarding the virtual currency transaction for the operator confirming. Following is to execute the step (S3115′) that is of the printing unit 16 printing a receipt corresponding to the billing information. For further detail, after the operator confirms the billing information shown on the display unit 15, the printing unit 16 prints out a receipt corresponding to the billing information for storage. In case the transaction has some problems later, the receipt is an evidence.

When an operator in prior arts conducts a virtual currency transaction such as buying/selling, etc. through a virtual currency teller machine, a plurality of authentications are required from the start of the operation to the final confirmation of the transaction, and the time of each authentication will be based on the amount of linking information. The larger amount of linking information, the longer waiting time. Generally speaking, it takes at least ten minutes or even dozens of minutes for each authentication, which is too time-consuming for operators. It is known that, there is still room for improvement in the transaction procedures of the virtual currency teller machine.

The present invention provides a virtual currency automatic exchange method of virtual currency teller machine 1, and is adopted to an operator to buy/sell virtual currencies through a mobile processing device 2, wherein the virtual currency teller machine 1 has a mining machine 11 for hash operations or other accounting and operations to obtain and store the virtual currencies in order to reduce the time of a plurality of authentications when conducting a virtual currency transaction and increase the speed of transaction, a connection interface unit 13, a processing unit 14, a video shooting unit 17, a display unit 15, a printing unit 16, and a cash box 12. In addition, when the operator lacks of the electronic wallet, the virtual currency teller machine 1 may guide the operator to apply the electronic wallet for consequent transactions. When buying/selling virtual currencies, the virtual currency teller machine 1 presents an exclusive QR code by means of the display unit 15, in order to let the operator use the image capturing unit 21 of the mobile processing device 2 read the exclusive QR code, so that the virtual currencies are obtained and stored in the electronic wallet, or that the cash is gained from the virtual currency teller machine 1 when selling out. After the transactions, the display unit 15 receives the billing information related to the transactions, and the printing unit 16 prints out a receipt corresponding to the billing information for storage. As a conclusion, the present invention has following advantages as of longer time for virtual currency transactions in prior arts, rapid finishing virtual currency transactions for reducing the time of authentication/confirmation, speedy obtaining virtual currencies, and in-time gaining cash corresponding to the amount of virtual currencies.

Although the invention has been disclosed and illustrated with reference to particular embodiments, the principles involved are susceptible for use in numerous other embodiments that will be apparent to persons skilled in the art. This invention is, therefore, to be limited only as indicated by the scope of the appended claims

What is claimed is:

1. A virtual currency automatic exchange method of virtual currency teller machine, adopted to an operator to buy/sell at least one kind of virtual currency through a mobile processing device and import/export a cash corresponding to the virtual currency to the operator, wherein the virtual currency teller machine has a mining machine for hash operations or other accounting and operations to obtain and store the virtual currency, a connection interface unit and a processing unit, wherein the processing unit is signally connected to the mining machine and the connection interface unit, comprising the steps of:
(a) connecting the connection interface unit with the mobile processing device;
(b) the processing unit determining whether the virtual currency can be bought/sold; and
(c) the processing unit controlling the mining machine to transfer out/in the virtual currency and receive/pay to the cash if yes.

2. The method for automatically exchanging the virtual currency of the virtual currency teller machine according to claim 1, wherein the step (a) further comprises the steps of:
(a1) determining whether the operator has an exclusive electronic wallet, if no, applying the electronic wallet; and
(a2) signing in to the exclusive electronic wallet if the operator does have the exclusive electronic wallet.

3. The method for automatically exchanging the virtual currency of the virtual currency teller machine according to claim 2, wherein the virtual currency teller machine further comprises a video shooting unit that is signally connected with the processing unit, and the mobile processing device is a smartphone, wherein the steps, after the step, further are of:
(a3) the video shooting unit capturing an identity certificate of the operator;
(a4) guiding the operator to input a smartphone number;
(a5) sending a one-time SMS password to the smartphone according to the smartphone number; and
(a6) guiding the operator to input the one-time SMS password in order to determine whether the one-time SMS password is true, otherwise re-inputting or re-sending the other one-time SMS password.

4. The method for automatically exchanging the virtual currency of the virtual currency teller machine according to claim 2, wherein the step (a1) further comprises the steps of:
(a11) guiding the operator to input an e-mail address;
(a12) sending a one-time e-mail password to the e-mail address according to the e-mail address;
(a13) guiding the operator to input the one-time e-mail password in order to determine the one-time e-mail password is true, otherwise re-inputting or re-sending the other one-time e-mail password; and
(a14) if yes, the electronic wallet being established.

5. The method for automatically exchanging the virtual currency of the virtual currency teller machine according to claim 1, wherein the virtual currency teller machine further comprises a display unit that is signally connected with the processing unit, the connection interface unit being a QR code on the display unit, the mobile processing device further comprising an image capturing unit, the step (b) comprising the steps of:
(b1) the display unit displaying the QR code in order to let the image capturing unit read and confirm an address of the virtual currency if the operator buys the virtual currency; and
(b2) guiding the operator to input a cash amount of buying the virtual currency.

6. The method for automatically exchanging the virtual currency of the virtual currency teller machine according to claim 5, wherein the virtual currency teller machine further comprises a printing unit that is signally connected with the processing unit, the step (c) comprising the steps of:
(c1) the processing unit confirming to receive the cash;
(c2) the display unit displaying billing information; and
(c3) the printing unit printing a receipt corresponding to the billing information.

7. The method for automatically exchanging the virtual currency of the virtual currency teller machine according to claim 1, wherein the virtual currency teller machine further comprises a display unit that is signally connected with the processing unit, the connection interface unit being a QR code on the display unit, the mobile processing device further comprising an image capturing unit, the step (b) comprising the steps of:
(b1′) guiding the operator to input a cash amount of selling the virtual currency if the operator sells the virtual currency;
(b2′) the processing unit confirming that the operator has enough virtual currency; and
(b3′) if yes, the display unit displays the QR code in order to let the image capturing unit read and confirm an address of the virtual currency.

8. The method for automatically exchanging the virtual currency of the virtual currency teller machine according to claim 7, wherein the virtual currency teller machine further comprises a printing unit that is signally connected with the processing unit, the step (c) comprising the steps of:
(c1′) the operator transferring the virtual currency;
(c2′) the printing unit printing a voucher of the cash amount of the virtual currency;
(c3′) the image capturing unit reading the voucher and allocating the corresponding cash to the operator;
(c4′) the display unit displaying billing information; and
(c5′) the printing unit printing a receipt corresponding to the billing information.

9. The method for automatically exchanging the virtual currency of the virtual currency teller machine according to claim 8, wherein the step (c3′) comprises the steps of:
(c31′) the processing unit determining whether the transferred virtual currency is received, if no, the display unit displaying that the transferred virtual currency is not received; and
(c32′) if yes, the display unit displaying that the transferred virtual currency is received, and allocating the corresponding cash to the operator.

10. The method for automatically exchanging the virtual currency of the virtual currency teller machine according to claim 1, the virtual currency teller machine further comprises a cash box that is signally connected with the processing unit, wherein the cash box is to store cash, so that the cash is collected/paid by the cash box.
